(19) United States
(12) Patent Application Publication
(10) Pub. No.: US 2017/0328042 A1
(43) Pub. Date: Nov. 16, 2017

(54) WALL FAUCET

(71) Applicant: DAHATA INC., Jiangmen (CN)

(72) Inventor: Jeffery Tzeng, Jiangmen (CN)

(21) Appl. No.: 15/155,122

(22) Filed: May 16, 2016

(51) Int. Cl. E03C 1/04; F16K 27/06; E03C 1/02

(52) U.S. Cl. CPC E03C 1/0403; F16K 27/06; E03C 2001/026

(57) ABSTRACT

The present invention provides a wall faucet including: an injection molded plastic faucet body defining a hot water inlet, a cold water inlet, at least one water outlet and a receiving chamber; a valve cartridge seat having two one-way valves accommodated therein suitably and a valve cartridge received in the receiving chamber; and a plate sleeve detachably assembled to the faucet body. The hot water inlet and/or the cold water inlet is formed with a body connector detachably assembled thereto. In the wall faucet of the present invention, the body connector is detachably assembled to the hot water inlet and/or the cold water inlet of the faucet body and, therefore, the body connector can be changed quickly and easily.

### FIELD OF THE INVENTION

The present invention generally relates to wall faucets and, more particularly, relates to a low cost wall faucet

### BACKGROUND OF THE INVENTION

At present, a conventional wall faucet generally includes a faucet body defining a hot water inlet, a cold water inlet, at least one water outlet and a receiving chamber; a valve cartridge suitably received in the receiving chamber; two one-way valves assembled to the hot water inlet and the cold water inlet respectively; and a plate sleeve assembled to the faucet body.

However, the conventional wall faucet at least has the following disadvantages.

Firstly, the faucet body is obtained via casting or forging and milling process of metal material, which not only leads to cumbersome process of the wall faucet, but also leads to high cost and high precision control requirements of the wall faucet.

Secondly, the two one-way valves respectively assembled to the hot water inlet and the cold water inlet of the faucet body will increase the size of the wall faucet, which also does not facilitate the installation of the wall faucet.

In view of the above, what is needed, therefore, is to provide a low cost wall faucet.

### SUMMARY OF THE INVENTION

One object of the present invention is to provide a low cost wall faucet.

In Accordance with one embodiment of the present invention, a wall faucet includes:
a faucet body defining a hot water inlet, a cold water inlet, at least one water outlet and a receiving chamber;
a valve cartridge seat having two one-way valves suitably accommodated therein and a valve cartridge received in the receiving chamber; and
a plate sleeve detachably assembled to the faucet body.

According to one aspect of the present invention, the hot water inlet and/or the cold water inlet is formed with a body connector detachably assembled thereto.

According to one aspect of the present invention, the body connector is a NPT screwed connector.

According to one aspect of the present invention, the body connector is a PEX quick connector.

According to one aspect of the present invention, the body connector is a 90 degree PEX quick connector.

According to one aspect of the present invention, the body connector is a WIRSBO quick connector.

According to one aspect of the present invention, the body connector is obtained via injecting molding of plastic material, and preferably, via injecting molding of PPSU material.

According to one aspect of the present invention, the valve cartridge seat comprises a first plate coupled to the valve cartridge, a second plate opposite to the first plate, and a first tube and a second tube for receiving a one-way valve respectively.

According to one aspect of the present invention, the valve cartridge seat is formed with a stiffener around the first tube and the second tube.

According to one aspect of the present invention, the at least one water outlet is provided with a plastic plug and a sealing ring is set between the faucet body and the plastic plug.

According to one aspect of the present invention, the faucet body is obtained via injecting molding of plastic material.

Compared with the prior art, the wall faucet of the present invention at least has the following advantages.

Firstly, the body connector is detachably assembled to the hot water inlet and/or the cold water inlet of the faucet body. Therefore, the body connector can be changed quickly and easily.

Secondly, the faucet body, the body connector, the valve cartridge seat, the two one-way valves, the plate sleeve and the plastic plug are all obtained via injecting molding of plastic material, which can improve productivity and precision of the wall faucet, as well as simplify the process and cut cost of the wall faucet.

Thirdly, the two one-way valves are received in the faucet body, which can reduce the size of the wall faucet and facilitate installation of the wall faucet.

Other advantages and novel features will be drawn from the following detailed description of preferred embodiments with the attached drawings. The accompanying drawings, which are incorporated in and constitute a part of this specification, illustrate embodiments of the present invention and, together with a general description of the invention given above, and the detailed description of the embodiments given below, serve to explain the principles of the invention:

### BRIEF DESCRIPTION OF THE DRAWINGS

FIG. 1 depicts an exemplary perspective view of a wall faucet according to a first embodiment of the present invention;

FIG. 2 depicts an exemplary assembled view of the wall faucet according to the first embodiment of the present invention;

FIG. 3 depicts an exemplary front side view of the wall faucet according to the first embodiment of the present invention;

FIG. 4A depicts an exemplary cross-sectional view of the wall faucet along a line A-A in FIG. 3, showing a flow direction of the water from a hot water inlet and a cold water inlet in a faucet body of the wall faucet;

FIG. 4B depicts an exemplary cross-sectional view of the wall faucet along a line B-B in FIG. 3, showing a flow direction of the water flowing out from the faucet body via water outlets of the wall faucet;

FIG. 5 depicts an exemplary perspective view of a wall faucet according to a second embodiment of the present invention, wherein a hot water inlet and a cold water inlet of the wall faucet each is coupled with a NPT screwed connector;

FIG. 6 depicts an exemplary assembled view of the wall faucet according to the second embodiment of the present invention;

FIG. 7 depicts an exemplary front side view of the wall faucet according to the second embodiment of the present invention;

FIG. 8A depicts an exemplary cross-sectional view of the wall faucet along a line A-A in FIG. 7, showing a flow direction of the water from the hot water inlet and the cold water inlet in a faucet body of the wall faucet;

FIG. 8B depicts an exemplary cross-sectional view of the wall faucet along a line B-B in FIG. 7, showing a flow direction of the water flowing out from the faucet body of the wall faucet via the water outlet;

FIG. 9 depicts an exemplary perspective view of a wall faucet according to a third embodiment of the present invention, wherein a hot water inlet and a cold water inlet of the wall faucet each is coupled with a PEX quick connector;

FIG. 10 depicts an exemplary assembled view of the wall faucet according to the third embodiment of the present invention;

FIG. 11 depicts an exemplary front side view of the wall faucet according to the third embodiment of the present invention;

FIG. 12A depicts an exemplary cross-sectional view of the wall faucet along a line A-A in FIG. 11, showing a flow direction of the water from the hot water inlet and the cold water inlet in a faucet body of the wall faucet;

FIG. 12B depicts an exemplary cross-sectional view of the wall faucet along a line B-B in FIG. 11, showing a flow direction of the water flowing out from the faucet body via water outlets;

FIG. 13 depicts an exemplary perspective view of a wall faucet according to a fourth embodiment of the present invention, wherein a hot water inlet and a cold water inlet of the wall faucet each is coupled with a 90 degree PEX quick connector;

FIG. 14 depicts an exemplary assembled view of the wall faucet according to the fourth embodiment of the present invention;

FIG. 15 depicts an exemplary front side view of the wall faucet according to the fourth embodiment of the present invention;

FIG. 16A depicts an exemplary cross-sectional view of the wall faucet along a line A-A in FIG. 15, showing a flow direction of the water from the hot water inlet and the cold water inlet in a faucet body of the wall faucet;

FIG. 16B depicts an exemplary cross-sectional view of the wall faucet along a line B-B in FIG. 15, showing a flow direction of the water flowing out from the faucet body via water outlets;

FIG. 17 depicts an exemplary perspective view of a wall faucet according to a fifth embodiment of the present invention, wherein a hot water inlet and a cold water inlet of the wall faucet each is coupled with a WIRSBO quick connector;

FIG. 18 depicts an exemplary assembled view of the wall faucet according to the fifth embodiment of the present invention;

FIG. 19 depicts an exemplary front side view of the wall faucet according to the fifth embodiment of the present invention;

FIG. 20A depicts an exemplary cross-sectional view of the wall faucet along a line A-A in FIG. 19, showing a flow direction of the water from the hot water inlet and the cold water inlet in a faucet body of the wall faucet; and

FIG. 20B depicts an exemplary cross-sectional view of the wall faucet along a line B-B in FIG. 19, showing a flow direction of the water flowing out from the faucet body via water outlets.

### DETAILED DESCRIPTION OF THE INVENTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

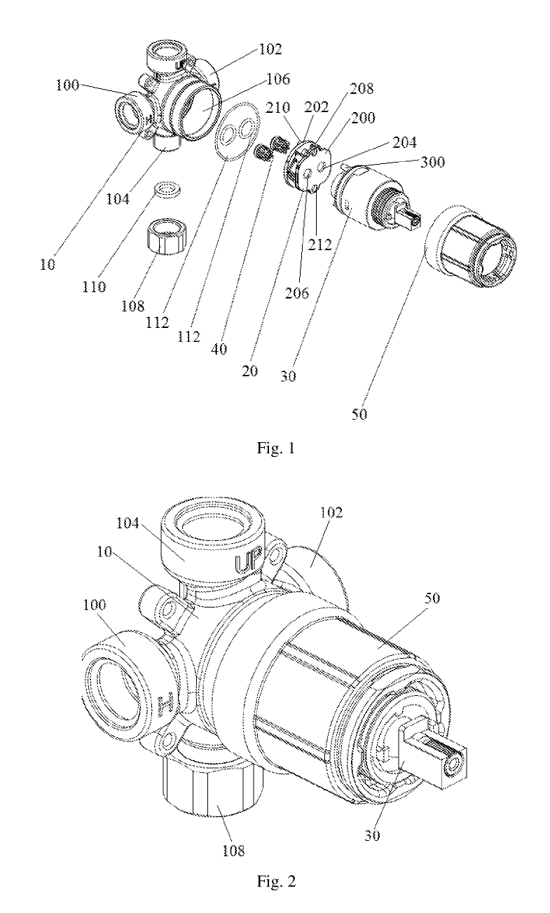

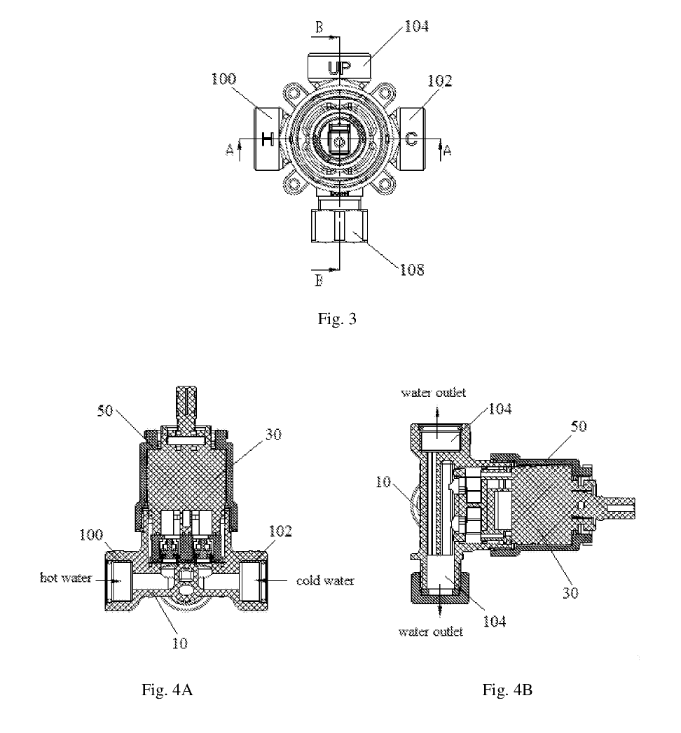

Referring to FIGS. 1 to 4, a wall faucet according to a first embodiment of the present invention includes a faucet body 10 defining a hot water inlet 100, a cold water inlet 102, at least one water outlet 104 and a receiving chamber 106; a valve cartridge seat 20 having two one-way valves 40 suitably accommodated therein and a valve cartridge 30 received in the receiving chamber 106; and a plate sleeve 50 detachably assembled to the faucet body 10.

The faucet body 10 is obtained via injecting molding of plastic material, so as to reduce the weight of the wall faucet. The faucet body 10 defines a hot water inlet 100, a cold water inlet 102, at least one water outlet 104 and a receiving chamber 106. According to actual requirements, the at least one water outlet 104 can be formed with a plug 108. The plug 108 is obtained via injecting molding of plastic material. To ensure the sealing performance, a sealing ring 110 is set between the plug 108 and the faucet body 10. When the plug 108 is provided, the wall faucet of the present invention can act as a wall shower faucet. When the plug 108 is not provided, the wall faucet of the present invention can act as a wall bathtub faucet.

The valve cartridge seat 20 and the valve cartridge 30 are suitably received in the receiving chamber 106. According to one embodiment of the present invention, the valve cartridge seat 20 and the valve cartridge 30 are both obtained via injecting molding of plastic material.

The valve cartridge seat 20 is formed with a first plate 200 coupled to the valve cartridge 30, a second plate 202 opposite to the first plate 200, and a first tube 204 defining a first hole and a second tube 206 defining a second hole between the first plate 200 and the second plate 202. The two one-way valves 40 are received in the first and the second holes correspondingly. In addition, in order to improve the strength of the valve cartridge seat 20, in the embodiment as illustrated, the valve cartridge seat 20 is formed with a stiffener 208 around the first tube 204 and the second tube 206.

The second plate 202 is formed with a second positioning pin 210 facing the faucet body 10. The faucet body 10 defines a corresponding second positioning hole (not shown). In this regard, the valve cartridge seat 20 can be accurately positioned in the receiving chamber 106 of the faucet body 10. The first plate 200 defines a pair of first positioning holes 212 facing the valve cartridge 30. The valve cartridge 30 is formed with a pair of first positioning pins 300. In assembly, the first positioning pins 300 are correspondingly inserted in the first positioning holes 212, so as to accurately assemble the valve cartridge seat 20 and the valve cartridge 30.

In order to ensure desirable sealing performance, a sealing ring 112 is seated between the valve cartridge seat 20 and the faucet body 10. Another sealing ring 112 is seated between the valve cartridge 30 and the faucet body 10.

There is no particular limitation to the valve cartridge 30, as long as the valve cartridge 30 can meet actual requirements of the wall faucet. For instance, according to one embodiment of the present invention, the valve cartridge 30 is a back to back balanced valve cartridge. According to another embodiment of the present invention, the valve cartridge 30 is a two-stage balanced valve cartridge.

The plate sleeve 50 is obtained via injecting molding of plastic material. The plate sleeve 50 can be detachably assembled to the faucet body 10 via thread connection.

Referring to FIGS. 1 to 4, the assembly of the wall faucet according to the first embodiment of the present invention is detailed as following.

Firstly, the valve cartridge seat 20 is seated in the receiving chamber 106 of the faucet body 10. A sealing ring 112 is seated between the valve cartridge seat 20 and the faucet body 10. The two one-way valves 40 are suitably received in the first hole of the first tube 204 and the second hole of the second tube 206 respectively. The hot water inlet 100 and the cold water inlet 102 each is in communication with the two one-way valves 40 respectively. Another sealing ring 112 is seated between the one-way valve 40 and the faucet body 10. The second positioning pin 210 of the second plate 202 is inserted into a corresponding second positioning hole defined in the faucet body 10.

Secondly, the valve cartridge 30 is assembled to the valve cartridge seat 20, with the first positioning pin 300 being inserted into a corresponding first positioning hole 212 defined in the valve cartridge seat 20.

Thirdly, the plate sleeve 50 is detachably assembled to the faucet body 10 via thread connection.

Finally, the plug 108 is assembled to the at least one water outlet 104 according to actual requirement. When the plug 108 is provided, the wall faucet of the present invention can act as a wall shower faucet. When the plug 108 is not provided, the wall faucet of the present invention can act as a wall bathtub faucet.

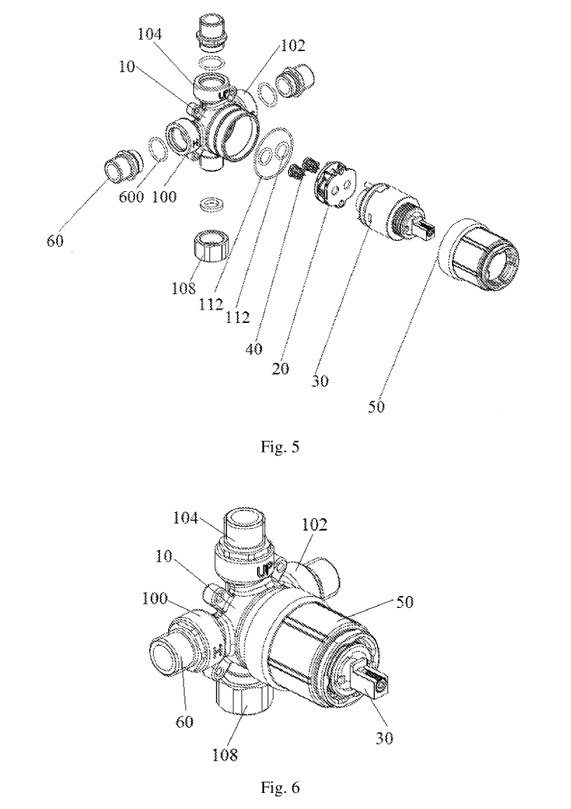

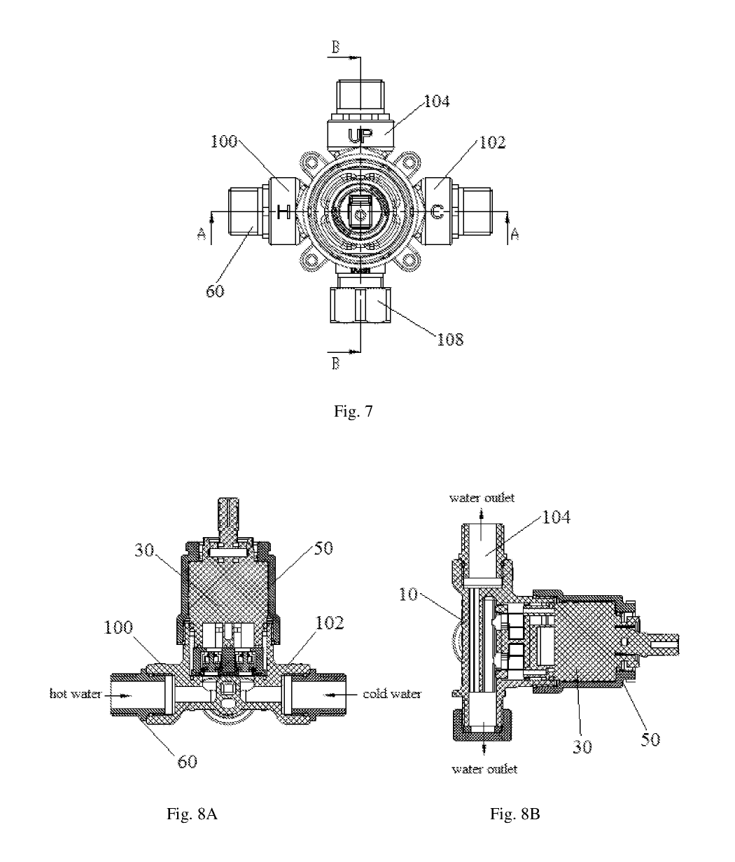

FIGS. 5 to 8 depict a wall faucet according to a second embodiment of the present invention. The second embodiment of the present invention differs from the first embodiment of the present invention only in that the hot water inlet 100 and/or the cold water inlet 102 is coupled with a NPT screwed connector 60. The screwed NPT connector 60 is obtained via injecting molding of plastic material, such as PPSU material. The screwed NPT connector 60 is detachably assembled to the hot water inlet 100 and/or cold water inlet 102. To ensure desirable sealing performance, a sealing ring 600 is set between the screwed NPT connector 60 and the faucet body 10.

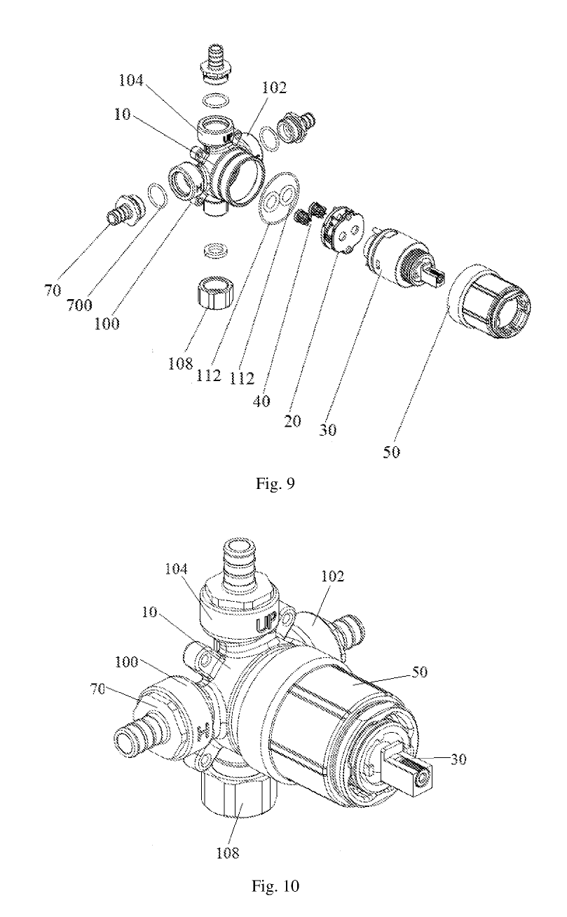

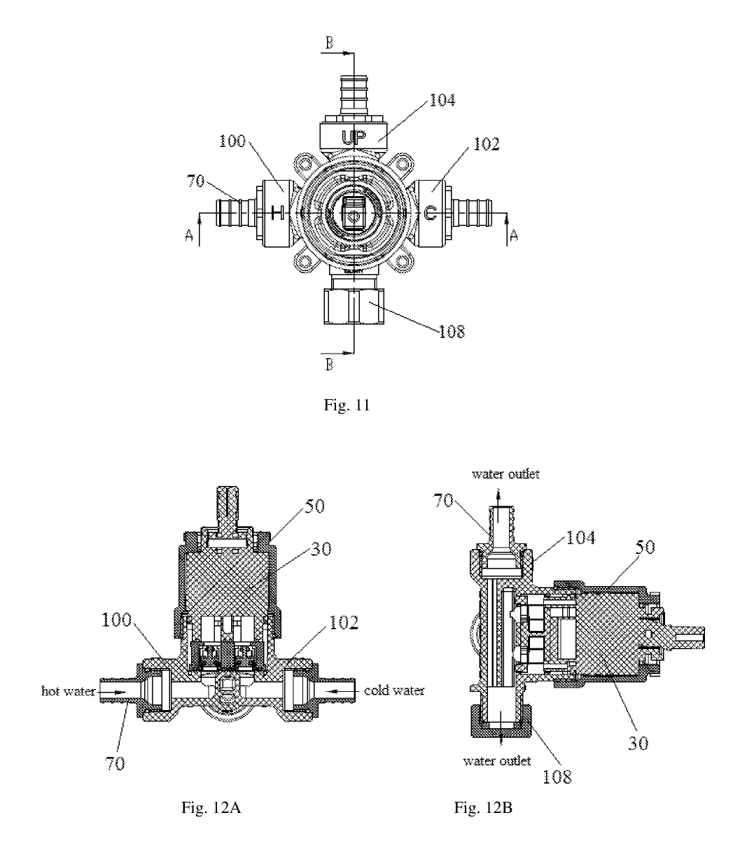

FIGS. 9 to 12 depict a wall faucet according to a third embodiment of the present invention. The third embodiment of the present invention differs from the first embodiment of the present invention only in that the hot water inlet 100 and/or the cold water inlet 102 is coupled with a PEX quick connector 70. The PEX quick connector 70 is obtained via injecting molding of plastic material, such as PPSU material. The PEX quick connector 70 is detachably assembled to the hot water inlet 100 and/or cold water inlet 102. To ensure desirable sealing performance, a sealing ring 700 is set between the PEX quick connector 70 and the faucet body 10.

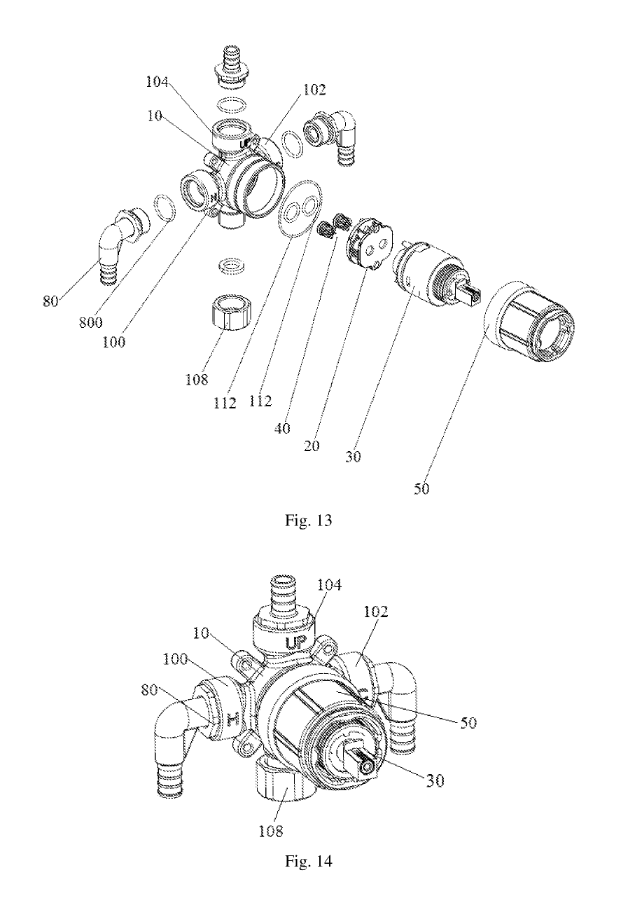

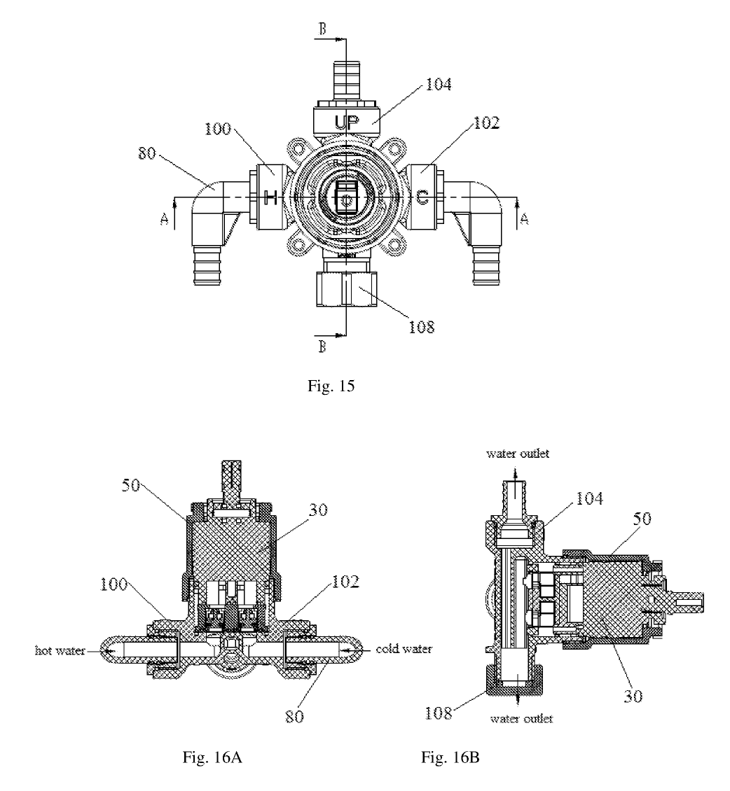

FIGS. 13 to 16 depict a wall faucet according to a fourth embodiment of the present invention. The fourth embodiment of the present invention differs from the first embodiment of the present invention only in that the hot water inlet 100 and/or the cold water inlet 102 is coupled with a 90 degree PEX quick connector 80. The 90 degree PEX quick connector 80 is obtained via injecting molding of plastic material, such as PPSU material. The 90 degree PEX quick connector 80 is detachably assembled to the hot water inlet 100 and/or cold water inlet 102. To ensure desirable sealing performance, a sealing ring 800 is set between the 90 degree PEX quick connector 80 and the faucet body 10.

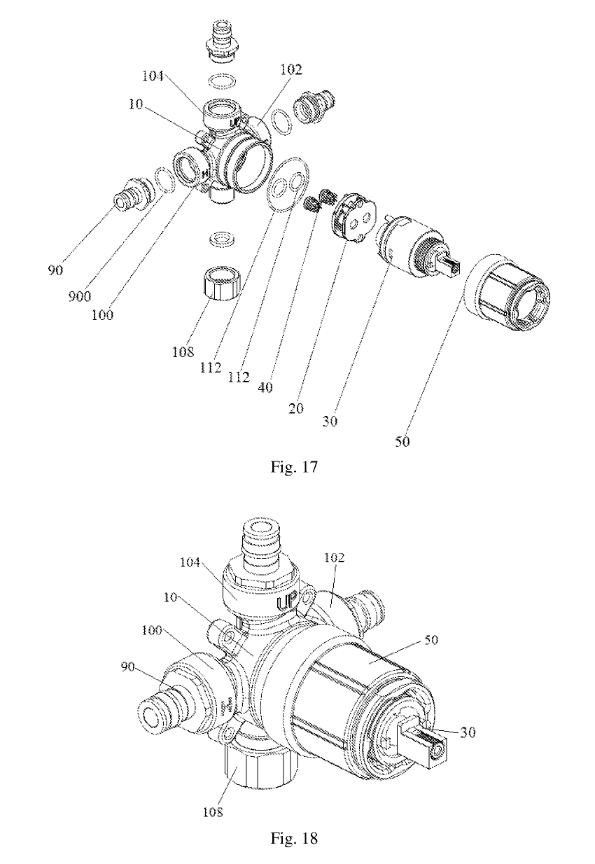

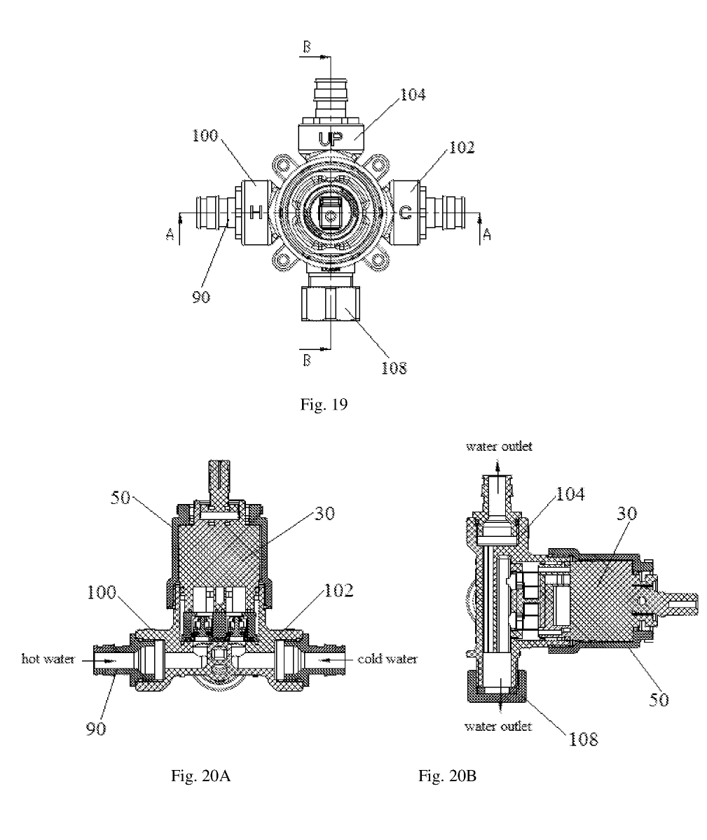

FIGS. 17 to 20 depict a wall faucet according to a fifth embodiment of the present invention. The fifth embodiment of the present invention differs from the first embodiment of the present invention only in that the hot water inlet 100 and/or the cold water inlet 102 is coupled with a WIRSBO quick connector 90. The WIRSBO quick connector 90 is obtained via injecting molding of plastic material, such as PPSU material. The WIRSBO quick connector 90 is detachably assembled to the hot water inlet 100 and/or cold water inlet 102. To ensure desirable sealing performance, a sealing ring 900 is set between the WIRSBO quick connector 90 and the faucet body 10.

In view of the embodiments as detailed above, the wall faucet of the present invention at least has the following advantages.

Firstly, the body connector 60,70,80,90 is detachably assembled to the hot water inlet 100 and/or the cold water inlet 102 of the faucet body 10. Therefore, the body connector can be changed quickly and easily.

Secondly, the faucet body 10, the body connector 60,70,80,90, the valve cartridge seat 20, the two one-way valves 40, the plate sleeve 50 and the plug 108 are all obtained via injecting molding of plastic material, which can improve productivity and precision of the wall faucet, as well as simplify the process and cut the cost of the wall faucet.

Finally, the two one-way valves 40 are received in the faucet body 10, which can reduce the size of the wall faucet and facilitate installation of the wall faucet.

While the present invention has been illustrated by the above description of the preferred embodiments thereof, while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and the illustrative examples shown and described.

What is claimed is:

1. A wall faucet, comprising:
a faucet body defining a hot water inlet, a cold water inlet, at least one water outlet and a receiving chamber;
a valve cartridge seat having two one-way valves suitably accommodated therein and a valve cartridge received in the receiving chamber; and
a plate sleeve detachably assembled to the faucet body.

2. The wall faucet of claim 1, wherein the hot water inlet and/or the cold water inlet is formed with a body connector detachably assembled thereto.

3. The wall faucet of claim 2, wherein the body connector is a NPT screwed connector.

4. The wall faucet of claim 2, wherein the body connector is a PEX quick connector.

5. The wall faucet of claim 2, wherein the body connector is a 90 degree PEX quick connector.

6. The wall faucet of claim 2, wherein the body connector is a WIRSBO quick connector.

7. The wall faucet of claim 2, wherein the body connector is obtained via injecting molding of plastic material, and preferably, via injecting molding of PPSU material.

8. The wall faucet of claim 1, wherein the valve cartridge seat comprises a first plate coupled to the valve cartridge, a second plate opposite to the first plate, and a first tube and a second tube for receiving a one-way valve respectively.

9. The wall faucet of claim 8, wherein the valve cartridge seat is formed with a stiffener around the first tube and the second tube.

10. The wall faucet of claim 1, wherein the at least one water outlet is provided with a plastic plug and a sealing ring is set between the faucet body and the plastic plug.

11. The wall faucet of claim 1, wherein the faucet body is obtained via injecting molding of plastic material.
